(19) United States
(12) Patent Application Publication
(10) Pub. No.: US 2015/0178961 A1
(43) Pub. Date: Jun. 25, 2015

(54) SYSTEM, METHOD, AND COMPUTER PROGRAM PRODUCT FOR ANGULAR SUBDIVISION OF QUADRATIC BEZIER CURVES

(71) Applicant: NVIDIA Corporation, Santa Clara, CA (US)

(72) Inventor: Tero Tapani Karras, Helsinki (FI)

(73) Assignee: NVIDIA Corporation, Santa Clara, CA (US)

(21) Appl. No.: 14/137,881

(22) Filed: Dec. 20, 2013

(51) Int. Cl. G06T 11/20

(52) U.S. Cl. CPC G06T 11/203; G06T 2207/20112

(57) ABSTRACT

A system, method, and computer program product are provided for subdividing a quadratic Bezier curve. The method includes the steps of receiving a quadratic Bezier curve defined by a plurality of control points including at least a first endpoint and a second endpoint. The quadratic Bezier curve is uniformly subdivided based on an angle between a first tangent at the first endpoint and a second tangent at the second endpoint to produce a piecewise representation of the quadratic Bezier curve including two or more Bezier curve segments.

### FIELD OF THE INVENTION

The present invention relates to two-dimensional path rendering, and more particularly to subdividing a quadratic Bezier curve.

### BACKGROUND

Conventional two-dimensional path rendering (i.e., vector graphics) is used in web applications and user interfaces to provide rendering resolution independent graphics. Two of the more common path rendering operations are to “fill” a path (i.e., fill the space bounded by outline of the path) and to “stroke” a path (i.e., paint the outline of the path). The path is typically defined in terms of two-dimensional Bezier curves.

One technique for performing efficient path stroking is to solve a third order polynomial equation at each (x,y) sample point on the path by executing a pixel shader program. Such a pixel shader program may be quite long, including as many as 100 shader instructions that are executed for each sample point. Some processors are not able to efficiently execute a long shader program. Thus, there is a need for addressing this issue and/or other issues associated with the prior art.

### SUMMARY

A system, method, and computer program product are provided for subdividing a quadratic Bezier curve. The method includes the steps of receiving a Bezier curve defined by a plurality of control points including at least a first endpoint and a second endpoint. The Bezier curve is uniformly subdivided based on an angle between a first tangent at the first endpoint and a second tangent at the second endpoint to produce a piecewise representation of the quadratic Bezier curve including two or more Bezier curve segments.

### BRIEF DESCRIPTION OF THE DRAWINGS

FIG. 1A illustrates a flowchart of a method for subdividing a quadratic Bezier curve, in accordance with one embodiment;

FIG. 1B illustrates a path defined by a set path segments, in accordance with the prior art;

FIG. 1C illustrates the path of FIG. 1B that is filled, in accordance with the prior art;

FIG. 1D illustrates the path of FIG. 1B that is stroked, in accordance with the prior art;

FIG. 2 illustrates a parallel processing unit (PPU), according to one embodiment;

FIG. 3 illustrates the streaming multi-processor of FIG. 2, according to one embodiment;

FIG. 4A illustrates a quadratic Bezier curve segment of a two-dimensional path, according to one embodiment;

FIG. 4B illustrates tangents of two quadratic Bezier curve segments that are generated during subdivision, in accordance with another embodiment;

FIG. 4C illustrates tangents of a quadratic Bezier curve and corresponding angles, in accordance with another embodiment;

FIG. 5A illustrates a quadratic Bezier curve subdivided uniformly by an angle between tangents of the endpoints, in accordance with another embodiment;

FIG. 5B illustrates the equal angles and corresponding points on the quadratic Bezier curve, in accordance with another embodiment;

FIG. 6A illustrates a stroked approximation of a quadratic Bezier curve, in accordance with the prior art;

FIG. 6B illustrates another stroked approximation of a quadratic Bezier curve, in accordance with another embodiment;

FIG. 6C illustrates another stroked approximation of a quadratic Bezier curve, in accordance with another embodiment;

FIG. 7A illustrates a flowchart of a method for producing a piecewise stroked approximation of a path defined by a set of Bezier curves, in accordance with one embodiment;

FIGS. 7B-7D illustrate pseudo code corresponding to a portion of a shader program that produces a piecewise stroked approximation of a two-dimensional path to stroke the two-dimensional path defined by a set of Bezier curves, in accordance with one embodiment; and

FIG. 8 illustrates an exemplary system in which the various architecture and/or functionality of the various previous embodiments may be implemented.

### DETAILED DESCRIPTION

A two-dimensional path is typically defined by a set of curve segments. Each segment may be represented as a line, a quadratic Bezier curve, or a higher order curve. In case the two-dimensional path comprises higher order curves, each such higher order curve may be adequately approximated using a set of quadratic Bezier curves. In the remaining discussion, we assume that such approximation has been performed a priori, so the two-dimensional path is defined by a set of quadratic Bezier curve segments.

When the two-dimensional path is stroked, the boundary of the stroked shape is defined in terms of one or more offset curves of the path. These offset curves may be approximated by a set of quadratic Bezier curves, in which case the number of quadratic Bezier curves may be minimized while also reducing a screen-space error between the true offset curves and the Bezier curves used to approximate the true offset curves (i.e., approximate offset curves) to be less than a pre-defined error threshold value. To construct the approximate offset curves, each quadratic Bezier curve segment may be subdivided into a set of smaller quadratic Bezier segments in order to satisfy the pre-defined error threshold. Then, the resulting quadratic Bezier segments may be used to construct a piecewise approximation of the offset curves.

To subdivide an individual quadratic Bezier curve, the number of quadratic Bezier curve segments in the set may be first determined. Then, the quadratic Bezier curve may be subdivided into the determined number of quadratic Bezier curve segments. Each quadratic Bezier curve segment in the set may be generated in sequence or in parallel. The number of quadratic Bezier curve segments in the set depends on the error threshold value and the shape of the original quadratic Bezier curve. One or more approximate offset curves corresponding to the piecewise representation of the quadratic Bezier curve may be generated. The approximate offset curves may be stroked, filled, or processed in some other manner.

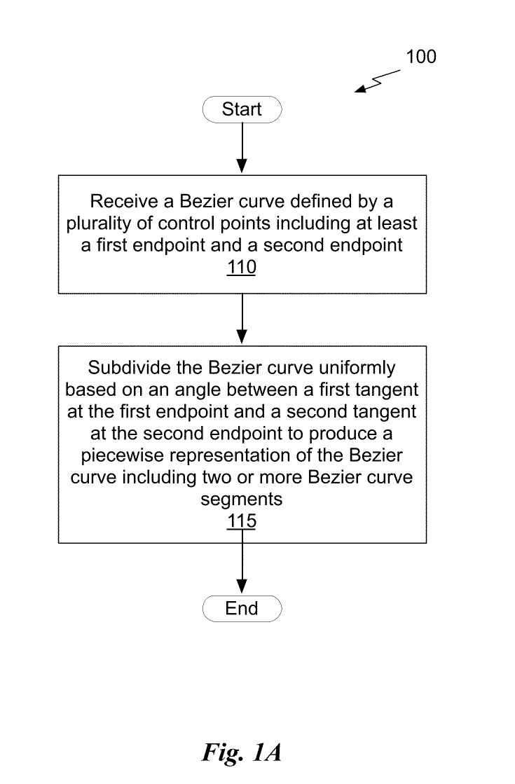

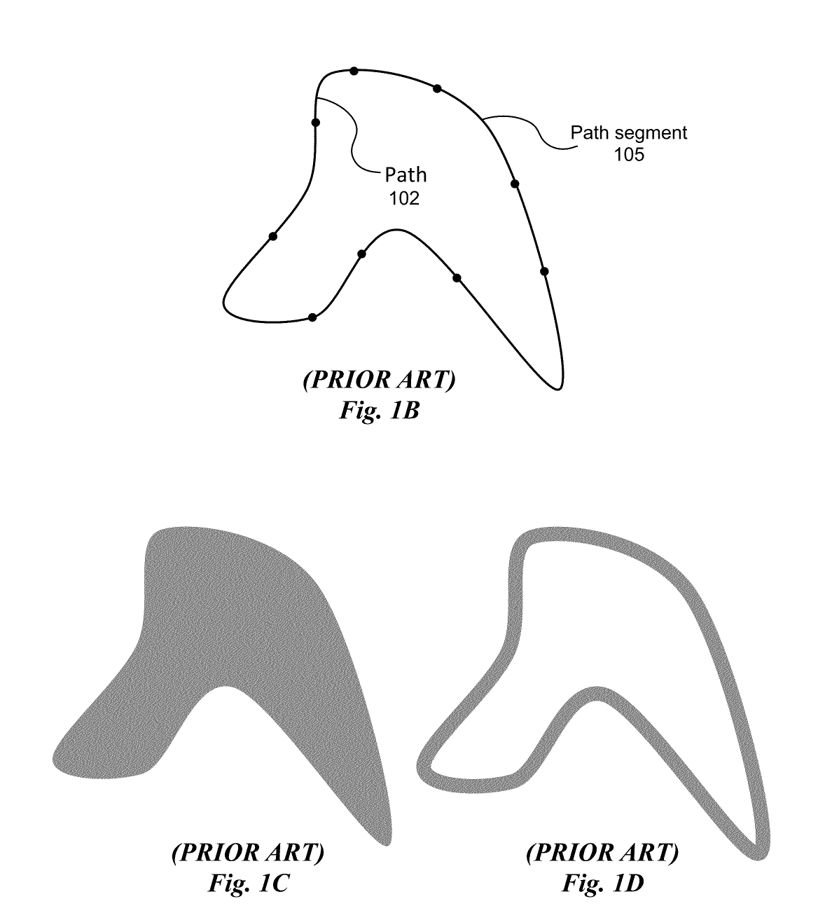

FIG. 1A illustrates a flowchart of a method 100 for subdividing a quadratic Bezier curve, in accordance with one embodiment. At step 110, a Bezier curve defined by a plurality of control points including at least a first endpoint and a second endpoint is received by a processor. In the context of the present description, the processor may be a graphics processor or a general purpose processor, either of which is configured to execute instructions of a shader program to perform two-dimensional path rendering operations. In one embodiment the Bezier curve is a quadratic Bezier curve. In the context of the present description, a quadratic Bezier curve p(t) is defined by three control points, where a first control point at t=0 and a second control point at t=1 correspond to respective endpoints of the quadratic Bezier curve and a third control point does not usually lie on the quadratic Bezier curve. As t increases from 0 to 1 the quadratic Bezier curve bends towards the third control point.

At step 115, the Bezier curve is uniformly subdivided based on an angle between a first tangent at the first endpoint and a second tangent at the second endpoint to produce a piecewise representation of the Bezier curve. The subdivision may be performed by a processor. In one embodiment, the Bezier curve is subdivided according to a shader program to produce the piecewise representation of the Bezier curve. The subdivision may be performed for additional quadratic Bezier curves that define a two-dimensional path to produce a piecewise representation of the two-dimensional path. The piecewise representation of the Bezier curve may include two or more Bezier curve segments. One or more of the Bezier curve segments may be quadratic Bezier curve segments. The piecewise representation of the two-dimensional path may then be stroked. A segment of the two-dimensional path that is a higher-order curve compared with a quadratic Bezier curve may be processed to produce one or more Bezier curves that approximate the higher-order curve. The Bezier curves may then be uniformly subdivided based on the angles between the respective endpoints.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

FIG. 1B illustrates a two-dimensional path 102 defined by a set of path segments, in accordance with the prior art. The path 102 includes the path segment 105 and other path segments defined by a plurality of control points including the shared endpoints. FIG. 1C illustrates the result of “filling” the path of FIG. 1B, in accordance with the prior art. Techniques for filling a two-dimensional path are well known in the art. FIG. 1D illustrates the result of “stroking” the path of FIG. 1B, in accordance with the prior art. In contrast with the techniques for filling the two-dimensional path 102, techniques for stroking a two-dimensional path are not as well developed. The method described in conjunction with FIG. 1A may be used to approximate the stroked shape of the two-dimensional path 102. Specifically, a set of quadratic Bezier curves maybe determined that approximate the stroked shape of the two-dimensional path 102. A processor may be configured to compute the set of quadratic Bezier curves.

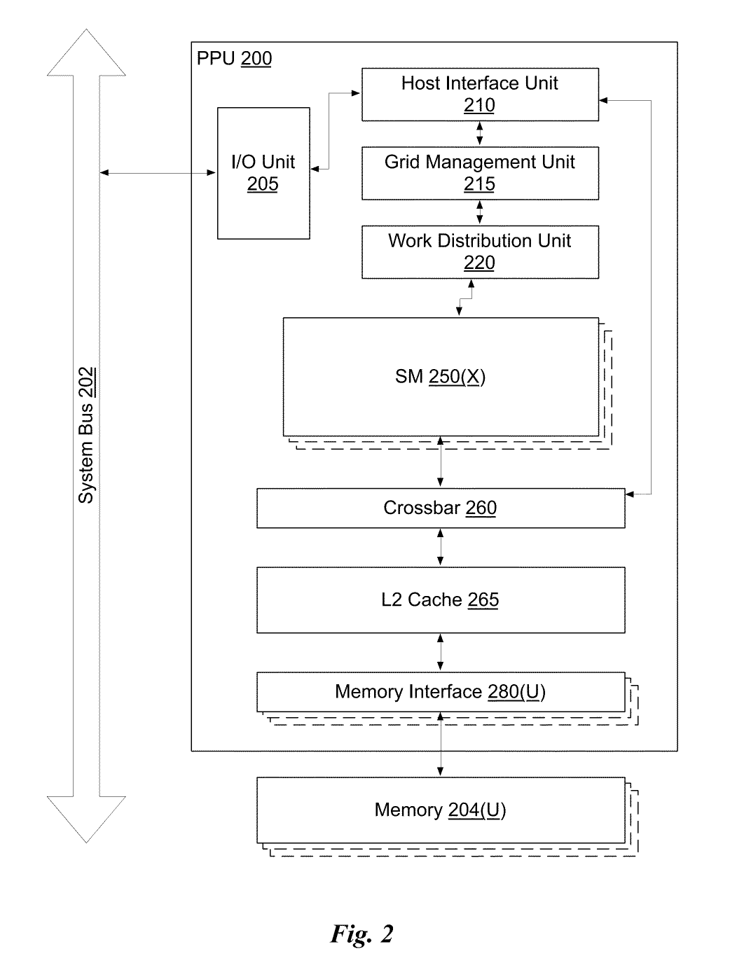

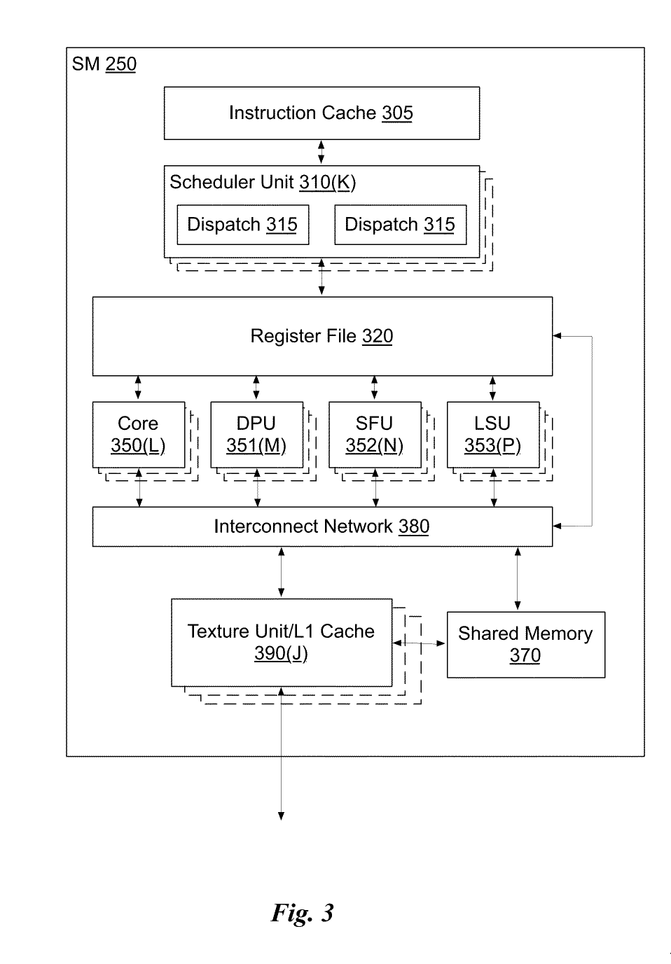

FIG. 2 illustrates a parallel processing unit (PPU) 200, according to one embodiment. While a parallel processor is provided herein as an example of the PPU 200, it should be strongly noted that such processor is set forth for illustrative purposes only, and any processor may be employed to supplement and/or substitute for the same. In one embodiment, the PPU 200 is configured to execute a plurality of threads concurrently in two or more streaming multi-processors (SMs) 250. A thread (i.e., a thread of execution) is an instantiation of a set of instructions executing within a particular SM 250. Each SM 250, described below in more detail in conjunction with FIG. 3, may include, but is not limited to, one or more processing cores, one or more load/store units (LSUs), a level-one (L1) cache, shared memory, and the like.

In one embodiment, the PPU 200 includes an input/output (I/O) unit 205 configured to transmit and receive communications (i.e., commands, data, etc.) from a central processing unit (CPU) (not shown) over the system bus 202. The I/O unit 205 may implement a Peripheral Component Interconnect Express (PCIe) interface for communications over a PCIe bus. In alternative embodiments, the I/O unit 205 may implement other types of well-known bus interfaces.

The PPU 200 also includes a host interface unit 210 that decodes the commands and transmits the commands to the grid management unit 215 or other units of the PPU 200 (e.g., memory interface 280) as the commands may specify. The host interface unit 210 is configured to route communications between and among the various logical units of the PPU 200.

In one embodiment, a program encoded as a command stream is written to a buffer by the CPU. The buffer is a region in memory, e.g., memory 204 or system memory, that is accessible (i.e., read/write) by both the CPU and the PPU 200. The CPU writes the command stream to the buffer and then transmits a pointer to the start of the command stream to the PPU 200. The host interface unit 210 provides the grid management unit (GMU) 215 with pointers to one or more streams. The GMU 215 selects one or more streams and is configured to organize the selected streams as a pool of pending grids. The pool of pending grids may include new grids that have not yet been selected for execution and grids that have been partially executed and have been suspended.

A work distribution unit 220 that is coupled between the GMU 215 and the SMs 250 manages a pool of active grids, selecting and dispatching active grids for execution by the SMs 250. Pending grids are transferred to the active grid pool by the GMU 215 when a pending grid is eligible to execute, i.e., has no unresolved data dependencies. An active grid is transferred to the pending pool when execution of the active grid is blocked by a dependency. When execution of a grid is completed, the grid is removed from the active grid pool by the work distribution unit 220. In addition to receiving grids from the host interface unit 210 and the work distribution unit 220, the GMU 215 also receives grids that are dynamically generated by the SMs 250 during execution of a grid. These dynamically generated grids join the other pending grids in the pending grid pool.

In one embodiment, the CPU executes a driver kernel that implements an application programming interface (API) that enables one or more applications executing on the CPU to schedule operations for execution on the PPU 200. An application may include instructions (i.e., API calls) that cause the driver kernel to generate one or more grids for execution. In one embodiment, the PPU 200 implements a SIMD (Single-Instruction, Multiple-Data) architecture where each thread block (i.e., warp) in a grid is concurrently executed on a different data set by different threads in the thread block. The driver kernel defines thread blocks that are comprised of k related threads, such that threads in the same thread block may exchange data through shared memory. In one embodiment, a thread block comprises 32 related threads and a grid is an array of one or more thread blocks that execute the same stream and the different thread blocks may exchange data through global memory.

In one embodiment, the PPU 200 comprises X SMs 250(X). For example, the PPU 200 may include 15 distinct SMs 250. Each SM 250 is multi-threaded and configured to execute a plurality of threads (e.g., 32 threads) from a particular thread block concurrently. Each of the SMs 250 is connected to a level-two (L2) cache 265 via a crossbar 260 (or other type of interconnect network). The L2 cache 265 is connected to one or more memory interfaces 280. Memory interfaces 280 implement 16, 32, 64, 128-bit data buses, or the like, for high-speed data transfer. In one embodiment, the PPU 200 comprises U memory interfaces 280(U), where each memory interface 280(U) is connected to a corresponding memory device 204(U). For example, PPU 200 may be connected to up to 6 memory devices 204, such as graphics double-data-rate, version 5, synchronous dynamic random access memory (GDDR5 SDRAM).

In one embodiment, the PPU 200 implements a multi-level memory hierarchy. The memory 204 is located off-chip in SDRAM coupled to the PPU 200. Data from the memory 204 may be fetched and stored in the L2 cache 265, which is located on-chip and is shared between the various SMs 250. In one embodiment, each of the SMs 250 also implements an L1 cache. The L1 cache is private memory that is dedicated to a particular SM 250. Each of the L1 caches is coupled to the shared L2 cache 265. Data from the L2 cache 265 may be fetched and stored in each of the L1 caches for processing in the functional units of the SMs 250.

In one embodiment, the PPU 200 comprises a graphics processing unit (GPU). The PPU 200 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. Attributes may include one of more of position, color, surface normal vector, texture coordinates, etc. The PPU 200 can be configured to process the graphics primitives to generate a frame buffer (i.e., pixel data for each of the pixels of the display). The driver kernel implements a graphics processing pipeline, such as the graphics processing pipeline defined by the OpenGL API.

An application writes model data for a scene (i.e., a collection of vertices and attributes) to memory. The model data defines each of the objects that may be visible on a display. The application then makes an API call to the driver kernel that requests the model data to be rendered and displayed. The driver kernel reads the model data and writes commands to the buffer to perform one or more operations to process the model data. The commands may encode different shader programs including one or more of a vertex shader, hull shader, geometry shader, pixel shader, etc. For example, the GMU 215 may configure one or more SMs 250 to execute a vertex shader program that processes a number of vertices defined by the model data. In one embodiment, the GMU 215 may configure different SMs 250 to execute different shader programs concurrently. For example, a first subset of SMs 250 may be configured to execute a vertex shader program while a second subset of SMs 250 may be configured to execute a pixel shader program. The first subset of SMs 250 processes vertex data to produce processed vertex data and writes the processed vertex data to the L2 cache 265 and/or the memory 204. After the processed vertex data is rasterized (i.e., transformed from three-dimensional data into two-dimensional data in screen space) to produce fragment data, the second subset of SMs 250 executes a pixel shader to produce processed fragment data, which is then blended with other processed fragment data and written to the frame buffer in memory 204. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

The PPU 200 may be included in a desktop computer, a laptop computer, a tablet computer, a smart-phone (e.g., a wireless, hand-held device), personal digital assistant (PDA), a digital camera, a hand-held electronic device, and the like. In one embodiment, the PPU 200 is embodied on a single semiconductor substrate. In another embodiment, the PPU 200 is included in a system-on-a-chip (SoC) along with one or more other logic units such as a reduced instruction set computer (RISC) CPU, a memory management unit (MMU), a digital-to-analog converter (DAC), and the like.

In one embodiment, the PPU 200 may be included on a graphics card that includes one or more memory devices 204 such as GDDR5 SDRAM. The graphics card may be configured to interface with a PCIe slot on a motherboard of a desktop computer that includes, e.g., a northbridge chipset and a southbridge chipset. In yet another embodiment, the PPU 200 may be an integrated graphics processing unit (iGPU) included in the chipset (i.e., Northbridge) of the motherboard.

FIG. 3 illustrates the streaming multi-processor 250 of FIG. 2, according to one embodiment. As shown in FIG. 3, the SM 250 includes an instruction cache 305, one or more scheduler units 310, a register file 320, one or more processing cores 350, one or more double precision units (DPUs) 351, one or more special function units (SFUs) 352, one or more load/store units (LSUs) 353, an interconnect network 380, a shared memory 370, and one or more texture unit/L1 caches 390.

As described above, the work distribution unit 220 dispatches active grids for execution on one or more SMs 250 of the PPU 200. The scheduler unit 310 receives the grids from the work distribution unit 220 and manages instruction scheduling for one or more thread blocks of each active grid. The scheduler unit 310 schedules threads for execution in groups of parallel threads, where each group is called a warp. In one embodiment, each warp includes 32 threads. The scheduler unit 310 may manage a plurality of different thread blocks, allocating the thread blocks to warps for execution and then scheduling instructions from the plurality of different warps on the various functional units (i.e., cores 350, DPUs 351, SFUs 352, and LSUs 353) during each clock cycle.

In one embodiment, each scheduler unit 310 includes one or more instruction dispatch units 315. Each dispatch unit 315 is configured to transmit instructions to one or more of the functional units. In the embodiment shown in FIG. 3, the scheduler unit 310 includes two dispatch units 315 that enable two different instructions from the same warp to be dispatched during each clock cycle. In alternative embodiments, each scheduler unit 310 may include a single dispatch unit 315 or additional dispatch units 315.

Each SM 250 includes a register file 320 that provides a set of registers for the functional units of the SM 250. In one embodiment, the register file 320 is divided between each of the functional units such that each functional unit is allocated a dedicated portion of the register file 320. In another embodiment, the register file 320 is divided between the different warps being executed by the SM 250. The register file 320 provides temporary storage for operands connected to the data paths of the functional units.

Each SM 250 comprises L processing cores 350. In one embodiment, the SM 250 includes a large number (e.g., 192, etc.) of distinct processing cores 350. Each core 350 is a fully-pipelined, single-precision processing unit that includes a floating point arithmetic logic unit and an integer arithmetic logic unit. In one embodiment, the floating point arithmetic logic units implement the IEEE 754-2008 standard for floating point arithmetic. Each SM 250 also comprises M DPUs 351 that implement double-precision floating point arithmetic, N SFUs 352 that perform special functions (e.g., copy rectangle, pixel blending operations, and the like), and P LSUs 353 that implement load and store operations between the shared memory 370 and the register file 320 via the J texture unit/L1 caches 390 and the interconnect network 380. The J texture unit/L1 caches 390 are coupled between the interconnect network 380 and the shared memory 370 and are also coupled to the crossbar 260. In one embodiment, the SM 250 includes 64 DPUs 351, 32 SFUs 352, and 32 LSUs 353. In another embodiment, the L1 cache is not included within the texture unit and is instead included with the shared memory 370 with a separate direct connection to the crossbar 260.

Each SM 250 includes an interconnect network 380 that connects each of the functional units to the register file 320 and to the shared memory 370 through the interconnect network 380. In one embodiment, the interconnect network 380 is a crossbar that can be configured to connect any of the functional units to any of the registers in the register file 320, to any of the J texture unit/L1 caches 390, or the memory locations in shared memory 370.

In one embodiment, the SM 250 is implemented within a GPU. In such an embodiment, the SM 250 comprises J texture unit/L1 caches 390. The texture unit/L1 caches 390 are configured to access texture maps (i.e., a 2D array of texels) from the memory 204 and sample the texture maps to produce sampled texture values for use in shader programs. The texture unit/L1 caches 390 implement texture operations such as anti-aliasing operations using mip-maps (i.e., texture maps of varying levels of detail). In one embodiment, the SM 250 includes 16 texture unit/L1 caches 390. As described further herein, the texture unit/L1 caches 390 are also configured to receive load and store requests from the LSUs 353 and to coalesce the texture accesses and the load and store requests to generate coalesced memory operations that are output to a memory system that includes the shared memory 370. The memory system may also include the L2 cache 265, memory 204, and a system memory (not shown).

The PPU 200 described above may be configured to perform highly parallel computations much faster than conventional CPUs. Parallel computing has advantages in graphics processing, data compression, biometrics, stream processing algorithms, and the like.

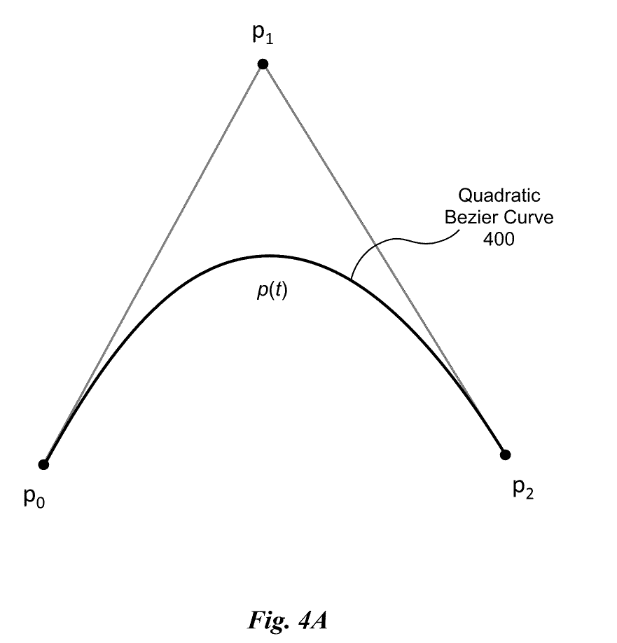

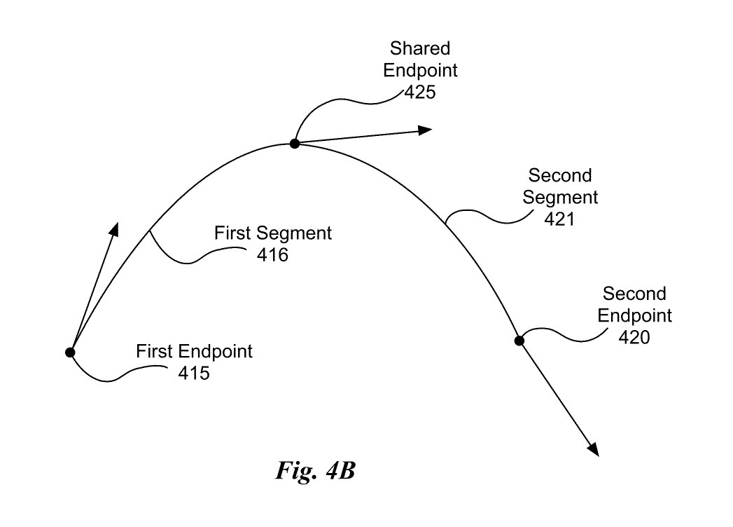

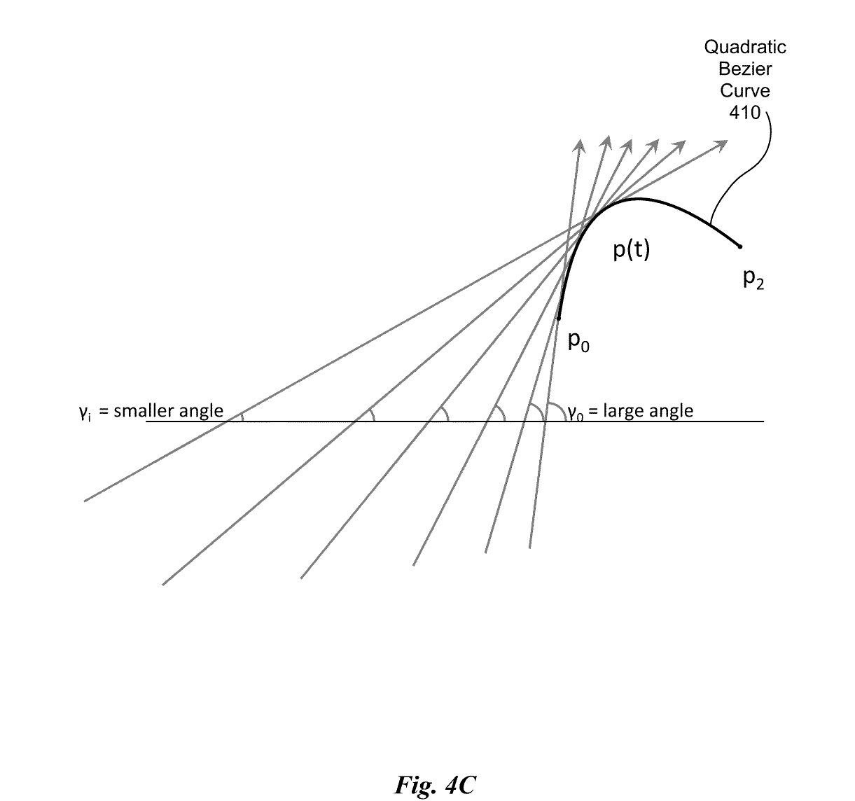

FIG. 4A illustrates a quadratic Bezier curve 400 that may be a curve segment of a two-dimensional path, in accordance with another embodiment. As previously described, a quadratic Bezier curve p(t) is defined by three control points, shown as p₀, p₁, and p₂. A first control point p₀ at t=0 and a second control point p₂ at t=1 correspond to endpoints and a third control point p₁ controls the curvature of the quadratic Bezier curve 400. As t increases from 0 to 1 the Bezier curve bends towards and then away from p₁. The Bezier curve may be represented in a parametric form using the Bernstein basis polynomials Bᵥⁿ(t) as follows:

p(t)=p₀B₀²(t)+p₁B₁²(t)+p₂B₂²(t)

Calculating the derivative of p(t) with respect to t produces the tangent p′(0)=p₁−p₀ for t=0, and p′(1)=p₂−p₁ for t=1.

A conventional technique for approximating the quadratic Bezier curve 400 with a set of line segments is to recursively subdivide the quadratic Bezier curve 400 to form a set of smaller Bezier curve segments, and then approximate each resulting curve segment with a line. At each step of the subdivision, it is determined if the amount of error resulting from the linear approximation is acceptable compared with the original quadratic Bezier curve 400. When the error is not acceptable, the segment is recursively divided in half until the error for each resulting linear segment is acceptable. As a result of the recursive subdivision, the total error may be unevenly distributed between the resulting linear segments. For a given total error, a better approximation may be achieved, in terms of visual quality, by distributing the error evenly between the linear segments.

When a quadratic Bezier curve is stroked, one or more offset curves need to be approximated for the quadratic Bezier curve. A predefined threshold value representing an amount of error that should not be exceeded may be defined as E, and a Bezier curve may be subdivided, as needed, to reduce the error between the resulting piecewise approximation of the offset curve and the actual offset curve so that the error does not exceed E. Rather than using linear segments to approximate the offset curve, the piecewise approximation may include two or more quadratic Bezier curve segments. In one embodiment, the approximation error of a particular quadratic Bezier curve segment depends on θ and r, where r is a stroke width parameter that represents half the stroke width (i.e., a constant). Subdividing the quadratic Bezier curve into multiple quadratic Bezier curve segments will effectively decrease the angle corresponding to each quadratic Bezier curve segment, and thus the maximum screen-space error will also decrease.

Intuitively, the maximum error should be the same for each quadratic Bezier curve segment. Therefore, since the error only depends on θ, the quadratic Bezier curve segments should have the same θ. The rationale is that decreasing the error of a particular quadratic Bezier curve segment will necessarily mean that the error of other quadratic Bezier curve segments will correspondingly increase. If the quadratic Bezier curve segments have different amounts of error, the approximation may be improved by decreasing a maximum error for one of the quadratic Bezier curve segments and increasing the error for other quadratic Bezier curve segments. If the quadratic Bezier curve segments all have the same amount of error, however, the approximation is optimal and cannot be improved any further by making such a trade.

FIG. 4B illustrates tangents of two quadratic Bezier curve segments that are generated during subdivision, in accordance with another embodiment. A first segment 416 is defined by a first endpoint 415 and a shared endpoint 425. A second segment 421 is defined by a second endpoint 420 and the shared endpoint 425. θ for the first segment 416 is the angle between a first tangent vector corresponding to the first endpoint 415 and a second tangent vector corresponding to the shared endpoint 425. θ for the second segment 421 is the angle between the second tangent vector and a third tangent vector corresponding to the endpoint 420. The values of θ are equal for the first segment 416 and the second segment 421.

FIG. 4C illustrates tangents of a quadratic Bezier curve 410 and corresponding angles, in accordance with another embodiment. Because p(t) represents a quadratic Bezier curve 410, the tangent vector p′(t) is linear with respect to the curve parameter t. The direction of the tangent vector will thus shift monotonically from p′(0) to p′(1) with increasing t. The shifting tangent vectors are shown in FIG. 4C as the curve parameter t increases starting from 0. To guarantee that the relative angle corresponding to each tangent vector is the same for each quadratic Bezier curve segment that is generated when the quadratic Bezier curve 410 is subdivided, the span of directions for the tangent vectors may be partitioned into a uniform set of sub-spans.

Instead of using tangent vectors, normal vectors may be used to perform the following computations. The angle of n₀ with respect to the positive x axis is computed and denoted by a. Similarly, the angle of n₁ with respect to n₀ is computed and denoted by β. The span of directions covered by the input curve can be represented as γ(s)=α+βs, where s ε[0,1].

To generate a quantity of n quadratic Bezier curve segments (where n is a positive integer), γ(s) is sampled at n+1 evenly spaced locations:

$$\begin{matrix}{γ}_{i} = γ ( \frac{i}{n} ) , where i = 0 , 1 , … m \\ = α + \frac{β i}{n}\end{matrix} \qquad equation 1$$

Each pair of adjacent values, γᵢ and γᵢ₊₁, defines one quadratic Bezier curve segment and n is the number of quadratic Bezier curve segments that will be generated by the subdivision. The curve parameter t corresponding to a given value of γ may be determined by forming the corresponding vector n_{γ}=(cos γ, sin γ), and then solving the value of t that satisfies:

(n_{γ}·p′(t))=0

(n_{γ}·((p₁−p₀)(1−t)+(p₂−p₁)t))=0

(n_{γ}·(p₁−p₀+(p₂−2p₁+p₀)t))=0

(n_{γ}·(p₁−p₀))+(n_{γ}(p₂−2p₁+p₀))t=0

This gives:

$$t = \frac{( {n}_{γ} \cdot ( {p}_{1} - {p}_{0} ) )}{( {n}_{γ} \cdot ( ( 2 {p}_{1} - {p}_{0} - {p}_{2} ) )} \qquad equation 2$$

t may be evaluated in this fashion for both γᵢ and γᵢ₊₁, and then De Casteljau's algorithm may be used to extract the control points for a quadratic Bezier curve segment of the input curve that lies between the two t-values.

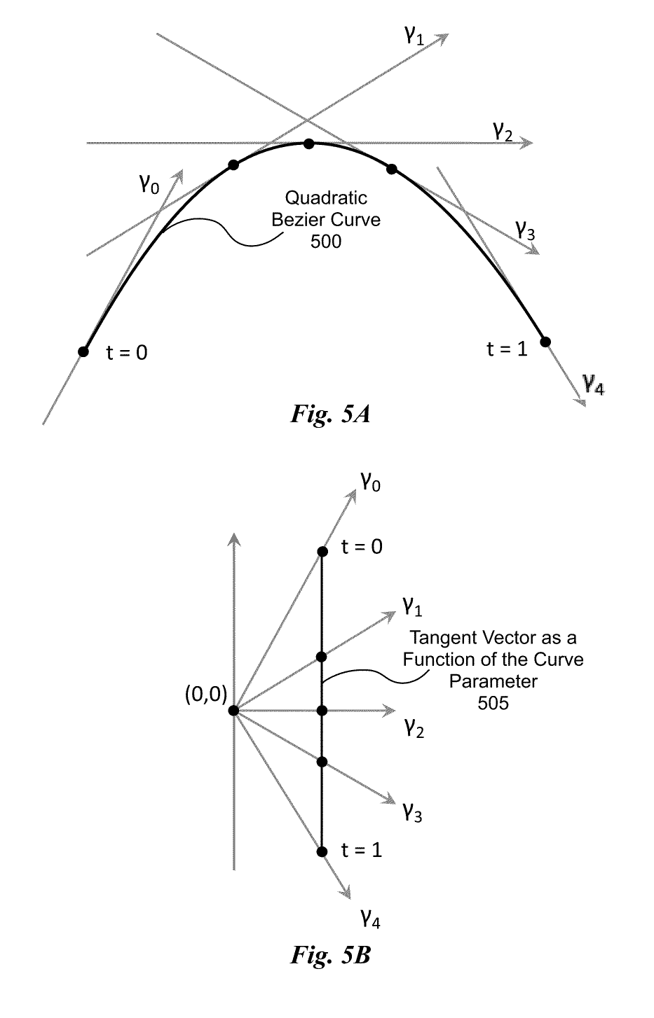

FIG. 5A illustrates a quadratic Bezier curve 500 subdivided uniformly by an angle between tangents of the endpoints, in accordance with another embodiment. The quadratic Bezier curve is subdivided into four quadratic Bezier curve segments corresponding to the tangent vectors γ₀, γ₁, γ₂, γ₃, and γ₄. The relative angles between each of the tangent vectors are equal. In one embodiment, the four quadratic Bezier curve segments are a portion of a piecewise representation of a two-dimensional path that includes the quadratic Bezier curve 500.

FIG. 5B illustrates the equal angles and corresponding curve parameter values on the quadratic Bezier curve, in accordance with another embodiment. As previously explained, the tangent vector of the curve is defined by p′(t), i.e., the derivative of p(t). The derivative varies linearly with respect to the curve parameter t, meaning that the tangent vectors follow a linear trajectory that is indicated by the tangent vector as a function of the curve parameter 505. A given sampled direction γᵢ can be represented by a line that passes through the origin and is oriented according to n_{γ}. In one embodiment, the value of the curve parameter corresponding to γᵢ is determined by finding the intersection between this line and the trajectory 505.

To approximate the stroked shape of the piecewise representation of the path comprising the quadratic Bezier curve segments, a technique for described by Tiller and Hanson (“Offsets of Two-dimensional Profiles” IEEE Computer Graphics and Applications, vol. 4, pp. 36-46, September 1984) may be used. The main idea behind the technique is to offset the edges of the control polygon along the corresponding normal vectors by half of the stroke width, denoted by r.

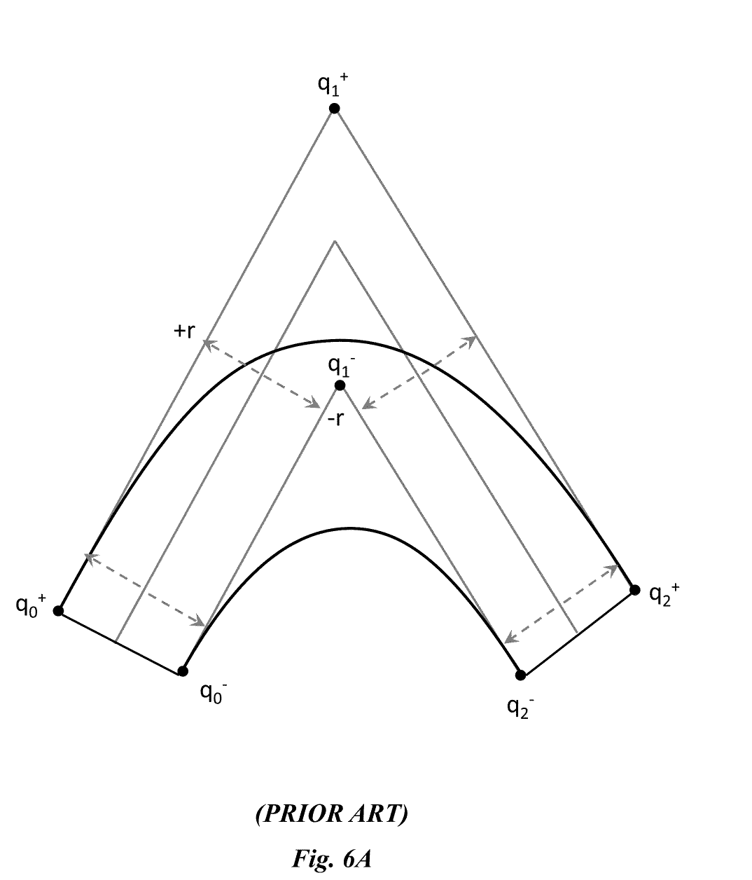

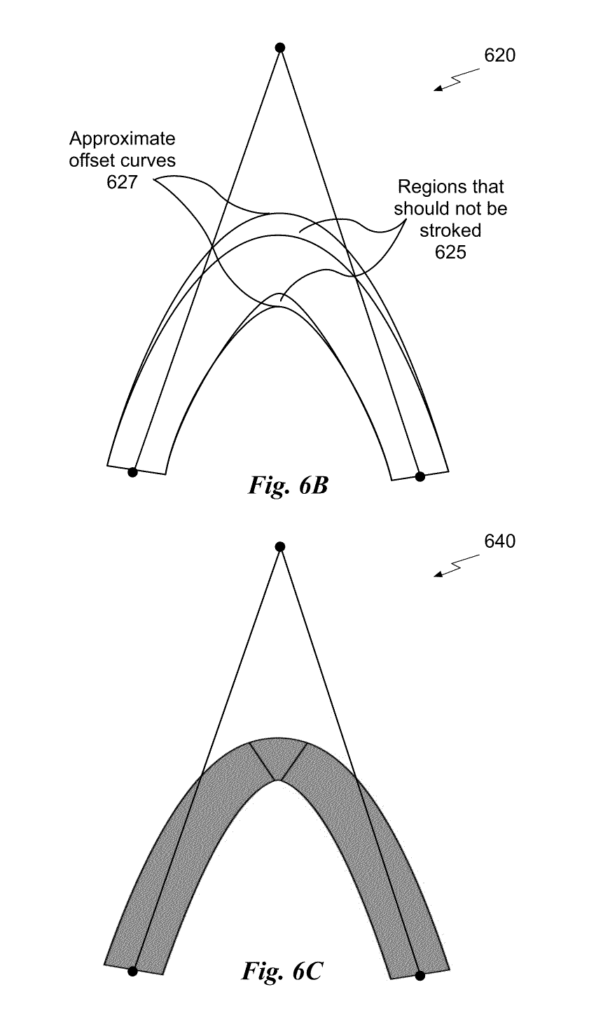

FIG. 6A illustrates a stroked approximation of a Bezier curve, in accordance with the prior art. As shown the center of the stroke region is thicker than the ends indicating that there is a significant error. FIG. 6B illustrates another stroked approximation of a quadratic Bezier curve 620, in accordance with another embodiment. The center of the stroke region between the approximate offset curves 627 is thicker than the ends indicating that the predetermined error value may be higher than desired. Regions that should not be stroked 625 are indicated and are outside of the true offset curves. FIG. 6C illustrates another stroked approximation of a quadratic Bezier curve 640, in accordance with another embodiment. The quadratic Bezier curve segment has been subdivided into three quadratic Bezier curve segments to better approximate a portion of the two-dimensional path. The center of the stroke region is now thinner and the error of the piecewise approximation is reduced.

Therefore, the quadratic Bezier curve should be subdivided using the technique described in conjunction with FIGS. 4A, 4B, 4C, 5A, and 5B to evenly distribute the error between multiple quadratic Bezier curve segments of the subdivided Bezier curve. FIG. 6A illustrates the parameters that are used to generate the approximate offset curves.

The unit normal vectors of the Bezier curve at t=0 and t=1 may be determined by normalizing the corresponding tangent vectors and rotating the normalized tangent vectors by 90 degrees:

$${n}_{0} = perpendicular ( \frac{{p}_{1} - {p}_{0}}{‖ {p}_{1} - {p}_{0} ‖} )$$

$${n}_{1} = perpendicular ( \frac{{p}_{2} - {p}_{1}}{‖ {p}_{2} - {p}_{1} ‖} )$$

Denoting half of the stroke width with r, the edges of the control polygon (p₀−p₁ and p₁−p₂) are offset by +r to obtain approximate offset curve defined by control points q₀⁺, q₁⁺, and q₂⁺. Similarly, the edges are offset by −r to obtain q₀⁻, q₁⁻, and q₂⁻:

q₀⁺=p₀+r·n₀

q₁⁺=p₁+r·2(n₀+n₁)/∥n₀+n₁∥²

q₂⁺=p₂+r˜n₁

q₀⁻=p₀−r·n₀

q₁¹=p₁−r·2(n₀+n₁)/∥n₀+n₁∥²

q₂⁻=p₂−r˜n₁

A particularly nice property of the approximation of the offset curves is that q′₊(0)∥q′₋(0)∥p′(0) and q′₊(1)∥q′₋(1)∥p′(1), i.e., the tangents of the offset curves are parallel to the tangent of the original curve at t=0 and t=1. Therefore, the approximation of the offset curves retain G¹ continuity-if each segment of a piecewise-quadratic G¹ continuous curve is approximated using the technique, the resulting approximate offset curves will also be G¹ continuous. In practice, failing to produce a G¹ continuous offset curve would result in visible artifacts between curve segments when viewed up close.

The technique may be applied to stroke the piecewise representation of the path. When two approximate offset curves have been computed for a quadratic Bezier curve segment, the approximate stroked shape of may be represented using a filled path using the following pseudo instructions:

MOVE TO {q₀⁺}
QUADRATIC CURVE TO (q₁⁺, q₂⁺}
LINE TO {q₂⁻}
QUADRATIC CURVE TO {q₁⁻, q₀⁻}
CLOSE PATH { }

The stroke “fragment” that is produced may be efficiently rendered on a GPU by rasterizing a bounding triangle mesh, and checking each sample against both approximate offset curves in the pixel shader.

An analysis may be performed to determine how accurate a particular piecewise representation of a quadratic Bezier curve is for producing a stroked two-dimensional path. The analysis may be based on the work of Elber and Cohen (“Error Bounded Variable Distance Offset Operator for Free Form Curves and Surfaces,” International Journal of Computational Geometry and Applications I, 1991, pp. 67-78) that presents a symbolic method for comparing two polynomial 2D curves. The squared distance between p(t) and q+(t) may be computed for a given value of t:

ε(t)=∥q₊(t)−p(t)|²

If the stroked piecewise approximation of the two-dimensional path were perfect, \sqrt{ε(t)} would be equal to r for all tε[0,1]. A lower bound εₘᵢₙ and an upper bound εₘₐₓ may be calculated for ε(t). The square root can be compared against r to see how much the approximate offset curve deviates from the ideal offset curve.

Substituting p(t) and q₊(t) in the above formula leads to:

$$\begin{matrix}ε ( t ) = {‖ ( {q}_{0}^{+} {B}_{0}^{2} + {q}_{1}^{+} {B}_{1}^{2} + {q}_{2}^{+} {B}_{2}^{2} ) - ( {p}_{0} {B}_{0}^{2} + {p}_{1} {B}_{1}^{2} + {p}_{2} {B}_{2}^{2} ) ‖}^{2} \\ = {‖ ( {q}_{0}^{+} - {p}_{0} ) {B}_{0}^{2} + ( {q}_{1}^{+} - {p}_{1} ) {B}_{1}^{2} + ( {q}_{2}^{+} - {p}_{2} ) {B}_{2}^{2} ‖}^{2} \\ = {r}^{2} \cdot {‖ {n}_{0} {B}_{0}^{2} + \frac{2 ( {n}_{0} + {n}_{1} )}{{‖ {n}_{0} + {n}_{1} ‖}^{2}} {B}_{1}^{2} + {n}_{1} {B}_{2}^{2} ‖}^{2}\end{matrix}$$

For clarity, the parameter t is omitted in the Bernstein basis polynomials Bᵥⁿ(t). The formula may be further simplified by substituting a=n₀, b=2(n₀+n₁)/∥n₀+n₁∥, and c=n₁:

$$\frac{ε ( t )}{{r}^{2}} = {‖ {aB}_{0}^{2} + {bB}_{1}^{2} + {cB}_{2}^{2} ‖}^{2} = ( a \cdot a ) {B}_{0}^{4} + ( a \cdot b ) {B}_{1}^{4} + ( \frac{2}{3} ( b \cdot b ) + \frac{1}{3} ( a \cdot c ) ) {B}_{2}^{4} + ( b \cdot c ) {B}_{3}^{4} + ( c \cdot c ) {B}_{4}^{4}$$

(a·b) is used to denote a dot product between a and b. Looking at the dot products more closely, one may observe that:

$$( a \cdot a ) = ( {n}_{0} \cdot {n}_{0} ) = 1$$

$$( c \cdot c ) = ( {n}_{1} \cdot {n}_{1} ) = 1$$

$$\begin{matrix}( a \cdot b ) = ( {n}_{0} \cdot 2 ( {n}_{0} + {n}_{1} ) \text{/} {‖ {n}_{0} + {n}_{1} ‖}^{2} ) \\ = 2 ( {n}_{0} \cdot ( {n}_{0} + {n}_{1} ) ) \text{/} ( ( {n}_{0} + {n}_{1} ) \cdot ( {n}_{0} + {n}_{1} ) ) \\ = 2 ( ( {n}_{0} \cdot {n}_{1} ) + 1 ) \text{/} ( 2 ( {n}_{0} \cdot {n}_{1} ) + 2 ) = 1\end{matrix}$$

$$\begin{matrix}( b \cdot c ) = ( 2 ( {n}_{0} + {n}_{1} ) \text{/} {‖ {n}_{0} + {n}_{1} ‖}^{2} \cdot {n}_{1} ) \\ = 2 ( {n}_{1} \cdot ( {n}_{0} + {n}_{1} ) ) \text{/} ( ( {n}_{0} + {n}_{1} ) \cdot ( {n}_{0} + {n}_{1} ) ) \\ = 2 ( ( {n}_{0} \cdot {n}_{1} ) + 1 ) \text{/} ( 2 ( {n}_{0} \cdot {n}_{1} ) + 2 ) = 1\end{matrix}$$

Substituting the computed dot products into ε(t) gives:

$$ε ( t ) \text{/} {r}^{2} = {B}_{0}^{4} + {B}_{1}^{4} + ( \frac{2}{3} ( b \cdot b ) + \frac{1}{3} ( a \cdot c ) ) {B}_{2}^{4} + {B}_{3}^{4} + {B}_{4}^{4}$$

In effect, ε(t)/r² is a fourth order scalar-valued Bezier curve. All of the control points are equal to 1, except for the third control point, whose value may be denoted by δ. An upper bound for the error may be computed as follows:

$$\begin{matrix}\frac{ε ( t )}{{r}^{2}} = {B}_{0}^{4} + {B}_{1}^{4} + δ {B}_{2}^{4} + {B}_{3}^{4} + {B}_{4}^{4} \\ = {B}_{2}^{4} ( δ - 1 ) + 1 \\ = 6 {{t}^{2} ( 1 - t )}^{2} ( δ - 1 ) + 1 \leq \\ \frac{3}{8} ( δ - 1 ) + 1 \\ = \frac{3}{8} δ + \frac{5}{8}\end{matrix}$$

Denoting the angle between n₀ and n₂ with θ, the expression of δ may be further simplified:

$$\begin{matrix}δ = \frac{2}{3} ( b \cdot b ) + \frac{1}{3} ( a \cdot c ) \\ = \frac{1}{3} cos θ + \frac{2}{3} {‖ b ‖}^{2} \\ = \frac{1}{3} cos θ + \frac{2}{3} {‖ \frac{2 ( {n}_{0} + {n}_{1} )}{{‖ {n}_{0} + {n}_{1} ‖}^{2}} ‖}^{2} \\ = \frac{1}{3} cos θ + \frac{8}{3} \text{/} {‖ {n}_{0} + {n}_{1} ‖}^{2} \\ = \frac{1}{3} cos θ + \frac{8}{3} \text{/} ( ( {n}_{0} + {n}_{1} ) \cdot ( {n}_{0} + {n}_{1} ) ) \\ = \frac{1}{3} cos θ + \frac{8}{3} \text{/} ( 2 ( {n}_{0} \cdot {n}_{1} ) + 2 ) \\ = \frac{1}{3} cos θ + \frac{4}{3} \text{/} ( cos θ + 1 )\end{matrix}$$

Based on the above formula, δ≧1 for all θ. Therefore, ε is bounded by εₘᵢₙ=r² and

$${ε}_{max} = {r}^{2} ( \frac{3}{8} δ + \frac{5}{8} ) .$$

An upper bound for the screen-space deviation between the approximate offset curve and the ideal offset curve is computed as:

$$\begin{matrix}\vert \sqrt{ε ( t )} - r \vert \leq \sqrt{{ε}_{max}} - r = \sqrt{{r}^{2} ( \frac{3}{8} δ + \frac{5}{8} )} - r \\ = r ( \sqrt{\frac{3}{8} δ + \frac{5}{8}} - 1 )\end{matrix}$$

Repeating the same reasoning for q₊(t), an identical expression is obtained for δ and ε(t). Therefore, the above formula for maximum screen-space deviation applies to both q₊(t) and q₋(t). To constrain the maximum screen-space error for each of the approximate offset curves below E, each quadratic Bezier curve segment should satisfy:

$$r ( \sqrt{\frac{3}{8} δ + \frac{5}{8}} - 1 )$$

$$δ \leq \frac{8}{3} {( E \text{/} r + 1 )}^{2} - \frac{5}{3}$$

$$\frac{1}{3} cos θ + \frac{4}{3} \text{/} ( cos θ + 1 ) \leq \frac{8}{3} {( E \text{/} r + 1 )}^{2} - \frac{5}{3}$$

Denoting the right-hand side with A and solving for θ gives:

$$θ \leq {cos}^{- 1} ( \frac{3}{2} A - \sqrt{\frac{9}{4} {A}^{2} + \frac{3}{2} A - \frac{15}{4}} - \frac{1}{2} ) \qquad equation 3$$

Since the angle/is divided into n equal sub-spans, θ=|β|/n. Solving for n produces n≧┌|β|/θ┐.

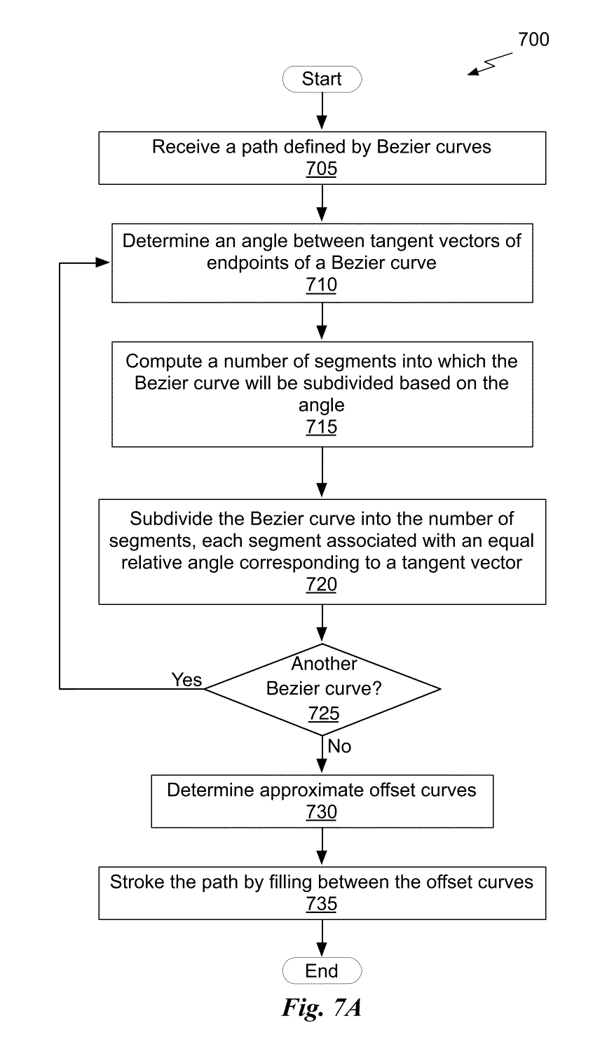

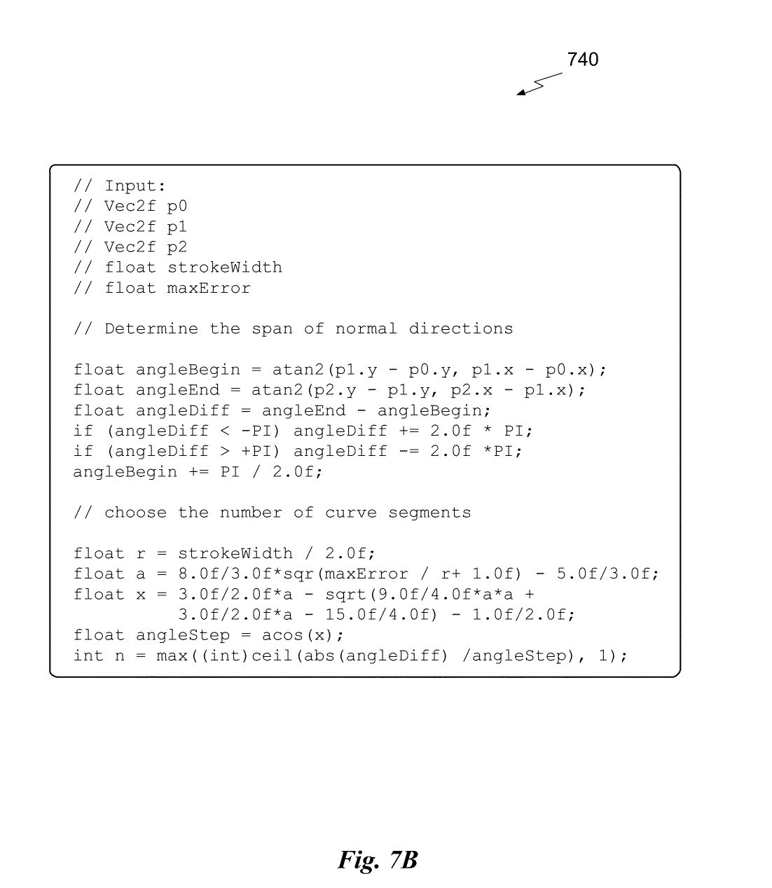

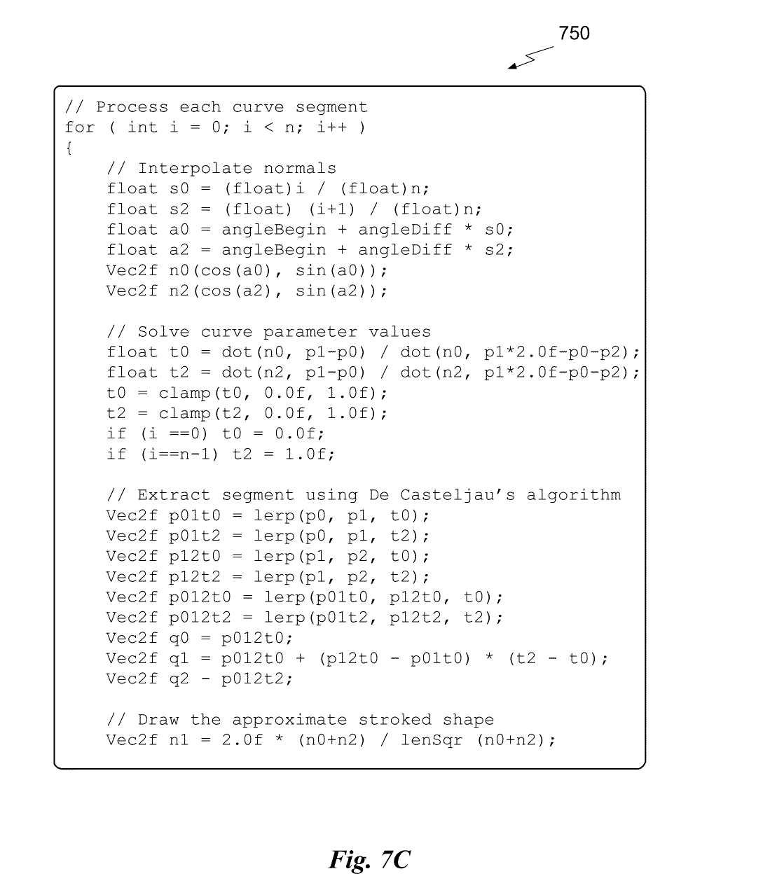

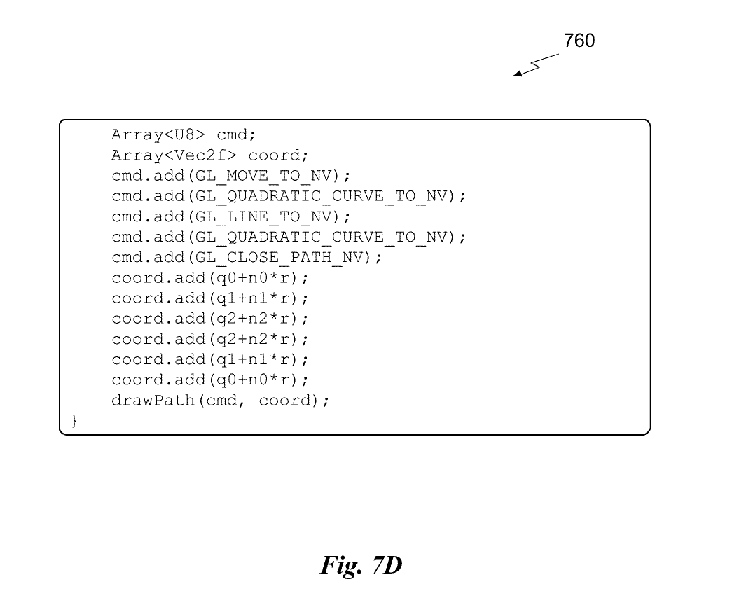

FIG. 7A illustrates a flowchart of a method 700 for stroking a two-dimensional path defined by a set of Bezier curves, in accordance with one embodiment. The method 700 may also be performed by a program, custom circuitry, or by a combination of custom circuitry and a program.

At step 705, a two-dimensional path defined by Bezier curves is received. At step 710, an angle θ between tangent vectors corresponding to endpoints of a Bezier curve is determined. In one embodiment, equation 3 is used to compute the angle. At step 715, a number of segments (n) into which the Bezier curve will be subdivided is computed based on the angle. In one embodiment, n is computed as ┌|β|/θ┐. Each segment may be a quadratic Bezier curve segment.

At step 720, the Bezier curve is subdivided into the number of segments, each segment associated with an equal relative angle corresponding to a tangent vector. The subdivision may be performed by computing the normal vectors γ for each segment using equation 1. Then the values of t defining endpoints of a quadratic Bezier curve segment may be computed according to equation 2. De Casteljau's algorithm may then be used to extract a segment of the Bezier curve corresponding to the quadratic Bezier curve segment.

At step 725, a determination is made as to whether another Bezier curve defining the two-dimensional path should be subdivided, and, if so, steps 710, 715, 720, and 725 are repeated. Otherwise, at step 730, one or more approximate offset curves are determined. At step 735, the two-dimensional path is stroked by filling a region between the approximate offset curves.

FIG. 7B illustrates pseudo code 740 corresponding to a portion of a shader program that computes a number (i.e., quantity) of quadratic Bezier curve segments to be generated for a Bezier curve that defines a portion of a two-dimensional path, in accordance with one embodiment. FIG. 7C illustrates pseudo code 750 corresponding to a portion of the shader program that produces a piecewise representation of a two-dimensional path, in accordance with one embodiment. FIG. 7D illustrates pseudo code 760 corresponding to a portion of the shader program that produces coordinates of a pair of approximate offset curves for a piecewise representation of the two-dimensional path, in accordance with one embodiment. In one embodiment, multiple threads may be configured to execute the shader program in parallel so that each thread subdivides a Bezier curve into two or more quadratic Bezier curve segments.

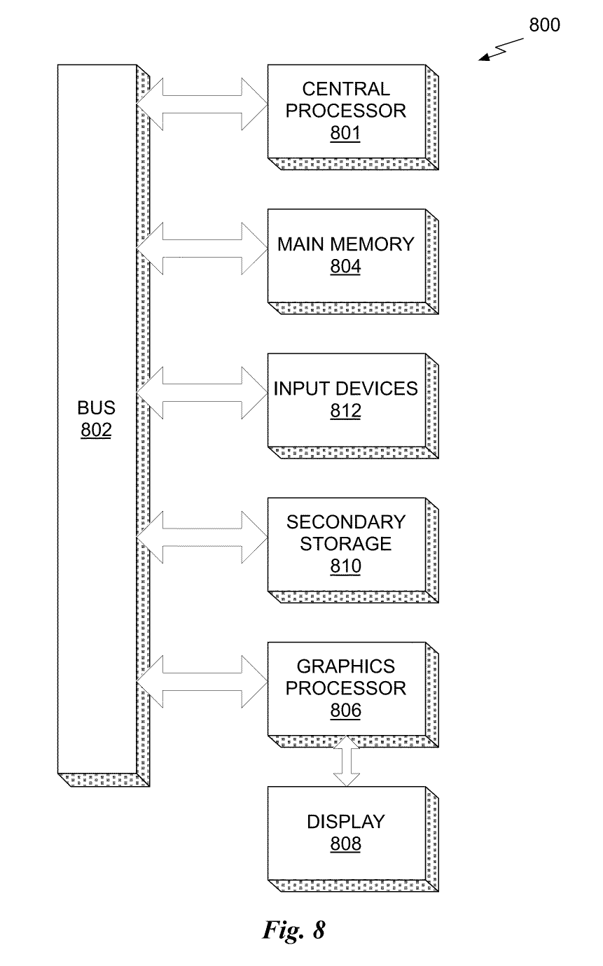

FIG. 8 illustrates an exemplary system 800 in which the various architecture and/or functionality of the various previous embodiments may be implemented. As shown, a system 800 is provided including at least one central processor 801 that is connected to a communication bus 802. The communication bus 802 may be implemented using any suitable protocol, such as PCI (Peripheral Component Interconnect), PCI-Express, AGP (Accelerated Graphics Port), HyperTransport, or any other bus or point-to-point communication protocol(s). The system 800 also includes a main memory 804. Control logic (software) and data are stored in the main memory 804 which may take the form of random access memory (RAM).

The system 800 also includes input devices 812, a graphics processor 806, and a display 808, i.e. a conventional CRT (cathode ray tube), LCD (liquid crystal display), LED (light emitting diode), plasma display or the like. User input may be received from the input devices 812, e.g., keyboard, mouse, touchpad, microphone, and the like. In one embodiment, the graphics processor 806 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 800 may also include a secondary storage 810. The secondary storage 810 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 804 and/or the secondary storage 810. Such computer programs, when executed, enable the system 800 to perform various functions. The memory 804, the storage 810, and/or any other storage are possible examples of computer-readable media.

In one embodiment, the architecture and/or functionality of the various previous figures may be implemented in the context of the central processor 801, the graphics processor 806, an integrated circuit (not shown) that is capable of at least a portion of the capabilities of both the central processor 801 and the graphics processor 806, a chipset (i.e., a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 800 may take the form of a desktop computer, laptop computer, server, workstation, game consoles, embedded system, and/or any other type of logic. Still yet, the system 800 may take the form of various other devices including, but not limited to a personal digital assistant (PDA) device, a mobile phone device, a television, etc.

Further, while not shown, the system 800 may be coupled to a network (e.g., a telecommunications network, local area network (LAN), wireless network, wide area network (WAN) such as the Internet, peer-to-peer network, cable network, or the like) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method comprising:
receiving a Bezier curve defined by a plurality of control points including at least a first endpoint and a second endpoint; and
subdividing, by a processor, the Bezier curve uniformly based on an angle between a first tangent at the first endpoint and a second tangent at the second endpoint to produce a piecewise representation of the Bezier curve including two or more Bezier curve segments.

2. The method of claim 1, wherein the Bezier curve is a quadratic Bezier curve that defines a portion of a two-dimensional path and the two or more Bezier curve segments are quadratic Bezier curves.

3. The method of claim 2, further comprising, prior to receiving the Bezier curve, approximating the two-dimensional path to produce a set of quadratic Bezier curves including the quadratic Bezier curve.

4. The method of claim 1, further comprising determining a pair of approximate offset curves corresponding to the two or more Bezier curve segments based on a stroke width parameter.

5. The method of claim 4, further comprising filling a region between the pair of approximate offset curves to stroke a portion of the two-dimensional path that is represented by the two or more Bezier curve segments.

6. The method of claim 1, further comprising, prior to subdividing, determining a number of Bezier curve segments into which the Bezier curve is subdivided.

7. The method of claim 6, wherein the number is computed based on the angle and a predetermined error value.

8. The method of claim 7, wherein the predetermined error value is based on a curve offset parameter.

9. The method of claim 1, wherein each Bezier curve segment is defined by a first segment endpoint and a second segment endpoint, and the angles between a first segment tangent at the first segment endpoint and a second segment tangent at the second segment endpoint for each Bezier curve segment are equal.

10. The method of claim 9, wherein the first and the second relative angles equal the angle divided by a quantity of the two or more Bezier curve segments into which the Bezier curve is subdivided.

11. The method of claim 1, wherein each processing thread in a set of processing threads is assigned to calculate one Bezier curve segment of the Bezier curve segments.

12. A system comprising:
a memory configured to store a Bezier curve defined by a plurality of control points including at least a first endpoint and a second endpoint; and
a processor that is configured to:
receive the Bezier curve; and
subdivide the Bezier curve uniformly based on an angle between a first tangent at the first endpoint and a second tangent at the second endpoint to produce a piecewise representation of the Bezier curve including two or more Bezier curve segments.

13. The system of claim 12, wherein the Bezier curve is a quadratic Bezier curve that defines a portion of a two-dimensional path and the two or more Bezier curve segments are quadratic Bezier curves.

14. The system of claim 13, wherein the processor is further configured to, prior to receiving the Bezier curve, approximate the two-dimensional path to produce a set of quadratic Bezier curves including the quadratic Bezier curve.

15. The system of claim 12, wherein the processor is further configured to determine a pair of approximate offset curves corresponding to the two or more quadratic Bezier curve segments based on a stroke width parameter.

16. The system of claim 15, wherein the processor is further configured to fill a region between the pair of approximate offset curves to stroke a portion of the two-dimensional path that is represented by the two or more Bezier curve segments.

17. The system of claim 12, wherein the processor is further configured to, prior to subdividing, determine a number of Bezier curve segments into which the Bezier curve is subdivided.

18. The system of claim 17, wherein the number is computed based on the angle and a predetermined error value.

19. The system of claim 12, wherein each Bezier curve segment is defined by a first segment endpoint and a second segment endpoint, and the angles between a first segment tangent at the first segment endpoint and a second segment tangent at the second segment endpoint for each Bezier curve segment are equal.

20. A computer-readable storage medium storing instructions that, when executed by a processor, causes the processor to perform steps comprising:
receiving a Bezier curve defined by a plurality of control points including at least a first endpoint and a second endpoint; and
subdividing, by a processor, the Bezier curve uniformly based on an angle between a first tangent at the first endpoint and a second tangent at the second endpoint to produce a piecewise representation of the Bezier curve including two or more Bezier curve segments.
